(19) United States
(12) Patent Application Publication
(10) Pub. No.: US 2011/0246322 A1
(43) Pub. Date: Oct. 6, 2011

(54) System and Method for Intelligent Product Configuration and Price Quotation

(75) Inventors: Lieven Wulteputte, Melle (BE); Dirk Vanden Berghe, Brakel (BE); Ken Meyfroodt, Brugge (BE); Edwin De Bock, Oudenaarde (Ename) (BE)

(73) Assignee: Spraying Systems Co., Wheaton, IL (US)

(21) Appl. No.: 13/046,394

(22) Filed: Mar. 11, 2011

Related U.S. Application Data
(62) Division of application No. 11/156,852, filed on Jun. 20, 2005, now abandoned.

(51) Int. Cl. G06Q 30/00

(52) U.S. Cl. 705/26.4

(57) ABSTRACT

A system and method for integrating sales personnel and engineering staff in an organization includes automatically generating design specifications for a proposed system by displaying a predetermined sequence of inquiries tailored to known design parameters. In response to the inquiries, the system and method generates required design specifications and other materials, including a pricing quotation, for the designed system.

### FIELD OF THE INVENTION

This invention relates generally to the art and science of automating one or more of the design, sale, and manufacturing aspects of products and/or systems in an organization. More particularly, this invention relates to a system and method for enabling the customized configuration, pricing, and engineering of equipment built from specified components.

### BACKGROUND OF THE INVENTION

For manufacturing enterprises, costs associated with engineering and sales processes are sources of significant constraints on profit margins. On the engineering side, the unpredictability of engineering labor costs during product design and manufacturing typically keeps such costs relatively high. At the sales level, while sales personnel may be skilled at certain tasks, they often lack the depth of engineering knowledge and resources to efficiently prepare a feasible proposal that is well-tailored to the application needs and constraints of particular customers. This is especially true of manufacturers of relatively complex equipment having a diverse base of potential purchasers and a great variety of potential configurations and applications, depending on the particular needs of the purchasers. Where such equipment is designed and constructed of components that are specified, or are capable of standardization, there are potential cost savings that are difficult to realize due to the sales and engineering costs associated with tailoring the equipment to meet the purchaser's needs.

One exemplary field of use in which these cost conditions and potential economies are present is that of industrial spray systems. Spray nozzles and related equipment have important operational applications in a wide range of fields, and they have thousands of sizes and configurations depending on the specific needs of the customer.

Currently there are many computer drawing and diagramming programs that are used as aids for designing complex systems for manufacture and sale, for example by enabling the computer-aided construction of piping and instrumentation diagrams (P&IDs). In addition to CAD software there are more accessible software design tools like Microsoft Corporation's Visio. However, even when such tools are customized for a particular industry or application, they are typically difficult for sales personnel to use in the field. Thus, mere drawing tools do not provide much practical improvement to the process of specifying a manufacturing project for a customer.

For example, it is possible to develop diagramming applications based on a software tool like Visio that enable a user to build a composite P&ID by dragging and dropping component graphical elements, such as the embodiments described in our pending U.S. patent application Ser. No. 10/463,164, filed on Jun. 17, 2003, entitled “Object-Oriented Operating System For A Spray Controller,” and incorporated herein by reference in its entirety. While such manipulations of a graphical user interface are generally intuitive, a salesperson typically does not have the requisite skills and training to know how to select the appropriate components, and how to align the various components of the diagram so that the composite diagram specifies a valid resulting system while conforming to the customer's application and pricing requirements.

Moreover, merely providing sales personnel with good diagramming tools does not inherently lead to improvements on the engineering side, and thus it is not enough to achieve economies in the overall process of developing a customized manufacturing project. Computer systems for facilitating the customized configuration, purchase and delivery of certain kinds of manufactured products have been developed, such as the “stores” on the websites of personal computer manufacturers. However, these are fairly simple systems involving equipment permitting only a relatively small number of configurations and uses, and they do not provide a solution for more challenging settings like that of spray systems manufacturing.

In the spray systems domain, the process of specifying a product implementation and generating a corresponding order for a customer is not sufficiently automated, integrated and standardized. As a result, many inefficiencies and diseconomies are present. The lack of a standardized and modular approach to designing and pricing equipment means that the same order might be built and priced differently by different engineers. Even after a system is specified for a customer, the generation of a finalized bill of materials may take one or two weeks to complete, and it may take a week for an engineer to produce an operating manual for the system. If a customer requires certain information about an order, such as the precise size of the product to be manufactured, it may take a number of days for an engineer to determine the answer.

For sufficiently complex systems, a price quotation might not be immediately available to a salesperson discussing a proposal with a customer, yet during such discussions it is often critical to have such information, particularly as the customer's requirements may change. Under such conditions, the order generation process is vulnerable to errors that are difficult to identify and fix. For example, one change to a proposal might fail to be reflected in an updated bill of materials. Other information about a project order is typically written up by a salesperson and may be poorly written and contain inaccuracies.

### SUMMARY OF THE INVENTION

Accordingly, it is a general object of the invention to overcome the deficiencies in the prior art.

It is a more specific object of the invention to provide a system and method that provides improved integration of various disciplines in an organization.

It is a further object of the invention to provide standardization in the quotation and design of products and systems produced by an organization.

It is another object of the invention to provide improved efficiency in an organization.

The present invention meets these and other objects in a system and method for integrating various aspects of an organization, such as sales personnel and engineering staff. The invention includes specifying a proposed system by displaying a predetermined sequence of inquiries tailored to parameters that are required to implement the system. In response to the inquiries, the system automatically generates an appropriate design implementation using various predefined components that are generally used in systems of that specific type. In one aspect, the system further generates proposal and quotation documents that enumerate the requirements of the system. In response to receipt of an order, such data may also be used to generate further documents as required by the organization to fulfill the order.

### BRIEF DESCRIPTION OF THE DRAWINGS

FIG. 1 is a simplified block diagram representation of a system according to the present invention.

FIG. 2 is a simplified block diagram representation illustrating certain application programs that may be installed on the computer of sales personnel according to an embodiment of the invention.

FIG. 3 is a simplified block diagram representation illustrating a exemplary configuration of a global data back-end processing system that may be used according to an embodiment of the invention.

FIG. 4 is a simplified block diagram representation illustrating various computing systems that may be configured within an organization to implement an embodiment of the invention.

FIG. 5 is a flow chart diagram illustrating a sequence of steps performed by the system according to a preferred embodiment of the present invention.

FIG. 6 is a flow chart diagram, continuing from FIG. 5, which illustrates a further sequence of steps performed by the system according to a preferred embodiment of the present invention.

FIG. 7 is a screen display illustrating a user interface of an automated quotation and proposal generating system according to the present invention.

FIG. 8 is a further screen display illustrating a user interface that presents fields for receiving input information concerning the overall problem addressed by the quotation and proposal generating system.

FIG. 9 is a screen display illustrating a user interface that queries the user with respect to specifications for a design solution according to one embodiment of the invention.

FIGS. 10 and 11 are screen displays that query the user with respect to a process of selecting certain control parameters of one type of a proposed solution that is generated by an embodiment of the invention.

FIG. 12 is a screen display that queries the user to select a physical configuration for the desired solution.

FIG. 13 illustrates a screen display that provides liquid specifications for an exemplary proposal according to the invention.

FIGS. 14 and 15 illustrate screen displays for querying the user to define process control signals that are necessary to implement the desired solution according to an illustrated embodiment of the present invention.

FIG. 16 is a screen display showing a generated Piping and Instrumentation Diagram (P&ID) generated by the present invention for an exemplary design solution proposal.

FIG. 17 is a further screen display that queries the user to identify documentation that is to be generated according to the present invention.

FIG. 18 is a screen display of a user interface for querying the user to describe a unique design problem.

FIG. 19 is a screen display of a user interface for providing a listing of component parts and a pricing tabulation according to an embodiment of the present invention.

### DETAILED DESCRIPTION OF THE PREFERRED EMBODIMENTS

Generally, the present invention relates to a system and method for integrating sales, engineering and other functions in an organization. In one embodiment, the invention includes specifying a system by displaying a predetermined sequence of inquiries tailored to engineering parameters of a design solution. In response to the inquiries, the system automatically creates an appropriate system design solution with the use of various known components. In this embodiment, the invention further produces output documents of a proposed system including price quotation and other engineering specifications. When such components are standardized, such as in the components that are used in the implementation of a spray solution, the system operates to generate a design proposal with all necessary documentation without the need for intensive design and engineering resources to be allocated.

The following description of a preferred embodiment is directed to functionality that is embodied in certain software and/or hardware implementations. However, those skilled in the art should appreciate that the invention is not limited to the specific hardware and/or software implementations described. Thus, for example, certain functionality that is described in terms of a software component or subcomponent could easily be implemented as one or multiple disparate software components that are executing on one or more computing systems.

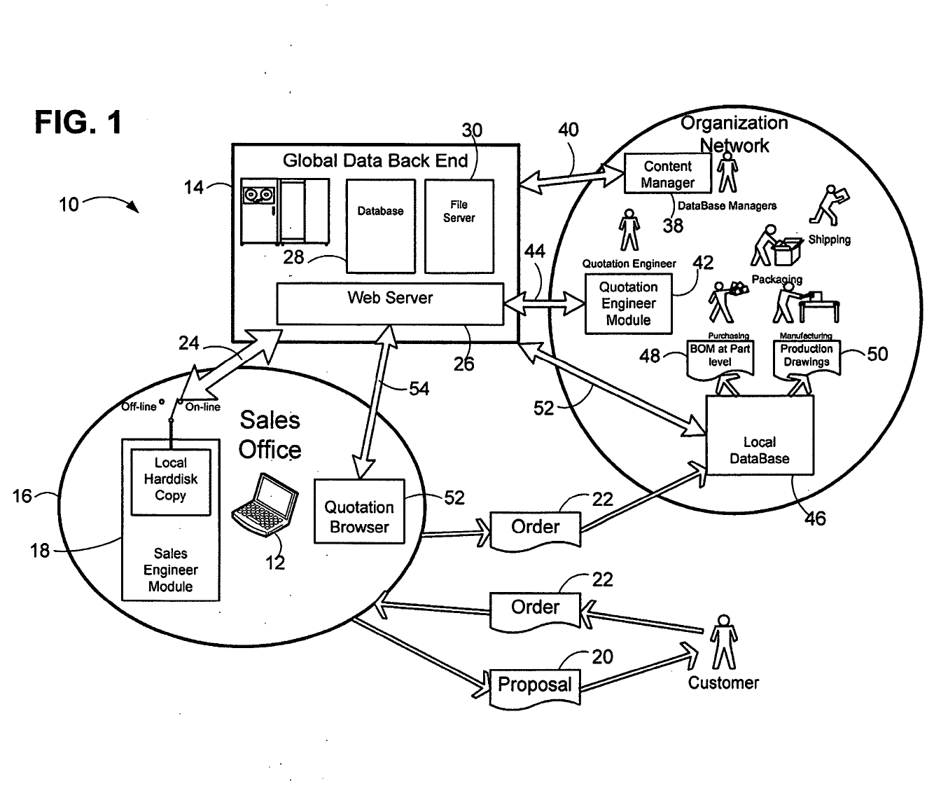

FIG. 1 is a block diagram illustrating broadly some features of an embodiment of the present invention. In the illustrated embodiment, an integrated design and quotation system 10 comprises at least a first computer 12 and a back-end computing system 14. In this instance, the computing systems 12 and 14 are configured in a client-server relationship. The first computer 12, which may be, for example, a laptop or other personal computing device, is operated by a user at a remote sales facility or other location. This user is typically associated with a sales office 16 or the like that is disposed at or near a customer location during the operation of various steps of the invention.

In operation, the sales office personnel receive requirements information from a customer pertaining to a needed or desired solution, such as an installation of a spray system solution. Specifically, the sales personnel, in consultation with a customer, interacts with one or more application programs, such as a Sales Engineer software module 18, running on the computer 12 in such a way that the program may operate in various modes. In one mode, the software module 18 operates off-line to generate a preliminary price estimate that may be viewed by the sales personnel through access of information, such as template information and prior quote information, stored on the computer 12.

In another mode, the software module 18, via connection with the back-end system 14, operates to create a customized proposal document 20 from information contained in a generated a requirements document file, the details of which are explained below. Based on input provided by the user, the system 10 tailors the proposal document 20 to the customer's specific needs. In the illustrated embodiment, when the invention is used to create a designed spray system, the proposal document 20 may be include necessary input parameters and other information to establish a solution specific for the customer.

Through interaction between the customer and sales personnel concerning a proposal that is generated by the system, the customer ultimately provides a purchase order 22 to the sales office 16, containing all of the necessary information for fulfillment. As explained in greater detail below, the purchase order 22 is electronically transmitted to the appropriate groups in an organization and fulfilled.

In one embodiment, the proposal document 20 contains information sufficient to provide a “complete specification” of the requested solution. In one embodiment, the proposal document 20 contains the following chapters: (1) an Introduction to the technology; (2) a Description of the Customer's Project or Problem addressed; (3) particular Specifications for the system; (4) an Overview of the solution; (5) Design Parameters; (6) a Functional Description of the system; (7) Price and Delivery information; (8) Installation, Support and Training information; (9) Terms and Conditions of sale; (10) how the system may be purchased; (11) a description of the value of the proposed system to the purchaser; and (12) Reference literature.

In the illustrated embodiment, the various parts of the proposal document 20 are generated based upon information bundled into a requirements document file. The requirements document file, or “quote” as used in this description, contains all the necessary quote-related information. It may be conceptualized as a software object that is created by the Sales Engineer software module 18 executing on the computer 12 and transmitted to the back-end 14 for verification and to permit creation of the Proposal document 20. In the illustrated example, the quote is embodied as a Visio file and an XML file. Thus, when the invention is used to implement a spray system solution, the quote may include information sufficient to create a preliminary Bill of Materials (BOM) for the proposed spray system solution. In addition, the document quote may include preliminary Piping and Instrumentation Diagram (P&ID) requirements for the proposed solution based upon representations of modular components provided by the application program running on the computer 12, as explained below. The quote optionally includes associated engineering specification requirements data for peripheral equipment, such as housing requirements for the spray system, package requirements, and documentation requirements, among other things.

The quote optionally includes an XML-based document that contains other information specific to the quotation being created. Such additional information includes customer information, a problem description, pricing information and other items. The process by which the quote is generated and verified is described in greater detail below.

In the illustrated embodiment, the data that is used to generate various parts of the Proposal document 20 are bundled into a Visio file and an XML file. In this way, the invention takes advantage of existing infrastructure to permit the various groups of an organization to efficiently exchange such information to each other, in readily definable machine-readable documents. That is, an XML type document may be created that is based on parsed data that includes mark-up data and character data. Mark-up data identifies logical structures within the document and sets of character data identify the content of the logical data structures. Those skilled in the art will appreciate, however, that different document formats may be utilized without departing from the spirit and scope of the invention.

The computer 12 is linked by way of one or more network connections 24 to the back-end computing system 14. In a preferred embodiment, the computing system 14 is a back-end system that includes one or more physical and/or logical entities. The computing system 14 is coupled to the first computer 12 through a virtual private network connection or other appropriate network connection. As shown, the computing system 14 may be configured to provide various services in an organization. In the illustrated embodiment, the system 14 includes a Web Server 26 for providing functionality such as creating and managing network connections with other computing devices in the network.

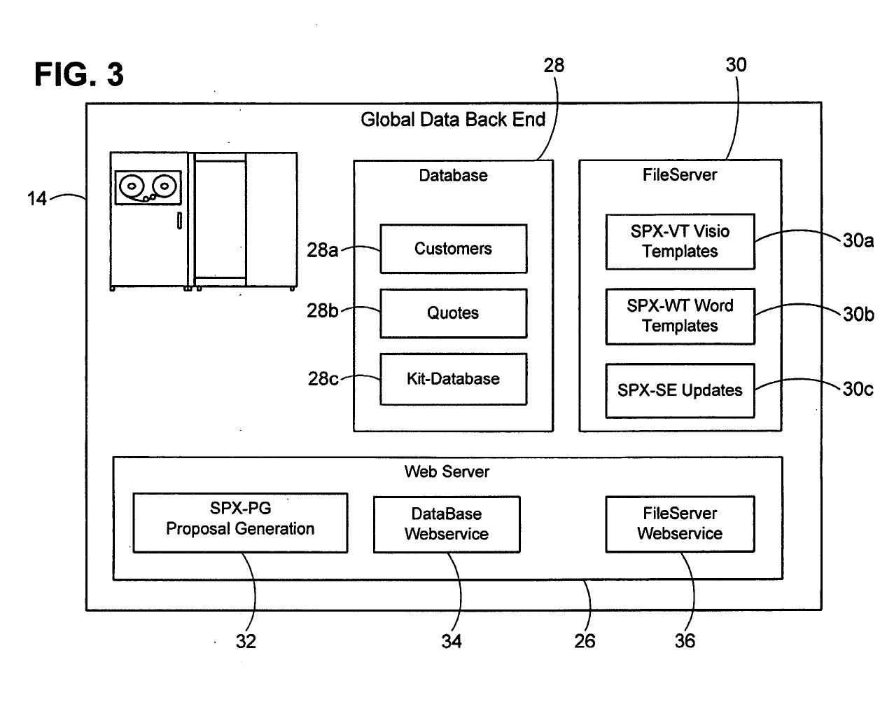

In addition, the system 14 includes a database 28 that provides a repository for information that will be used to create and verify proposals submitted by sales personnel. As shown in FIG. 3, the database is configured to contain entries relating to customer information 28a, previously generated quotes throughout the organization 28b and available pre-defined kits 28c that are used in generating a quotation, as explained in greater detail below.

Also, the computing system 14 includes a File Server 30 for providing various file services to other computing systems in the organization. As shown in FIG. 3, the File Server 30 may be configured to provide graphics templates 30a, document templates 30b and update information 30c, such as software updates for the software modules running on the sales personnel computer 12. Such templates are used for generating proposal documents in a desired format, such as Word or .pdf format. The templates preferably include information related to the customer, design parameters, spray solution details, a list of deliverables, pricing and optionally other information that is automatically inserted into the proposal document. Specifically, as shown in FIG. 3, when a request for a proposal is transmitted by the remote computer 12, a Proposal Generation component 32 operates in conjunction with a Database Webservice component 34 and a Fileserver Webservice component 36, all of which are part of the Webserver 26, to access the template information to create the requested proposal file.

Thus, the information used to ultimately create a document file containing the relevant requirements information may be transmitted to the back-end server 14 in a preferred embodiment. As noted above, the back-end 14 includes or is linked to a database 28 and Fileserver 30. At the server 14, the information extracted from the requirements document file regarding predefined components in the design of the product is matched to corresponding information in the database 28. From this and other information, the server 14 generates a proposal document file that may comprise a definitive price quotation for the proposed project. The proposal document file is transmitted back to the first computer 12 by way of a network connection 24.

Other computing devices and systems are preferably interconnected with the back-end system 14 within an organization. FIGS. 1 and 3 illustrate various functions that are either implemented via a network connection or otherwise. For example, an organization network may include a Content Manager software module 38 on which a database manager and other personnel may maintain. For updating and servicing the records maintained in the Fileserver 30, the Content Manager module 38 is coupled via a network connection 40 to the data back-end 14. In addition, a Quotation Engineering software module 42 includes functionality for quotation engineering staff to provide updated design kits and support for the various pieces of standardized designs that are supported by the system. By way of a network connection 44, the Quotation Engineering module 42 is coupled with the data back-end 14.

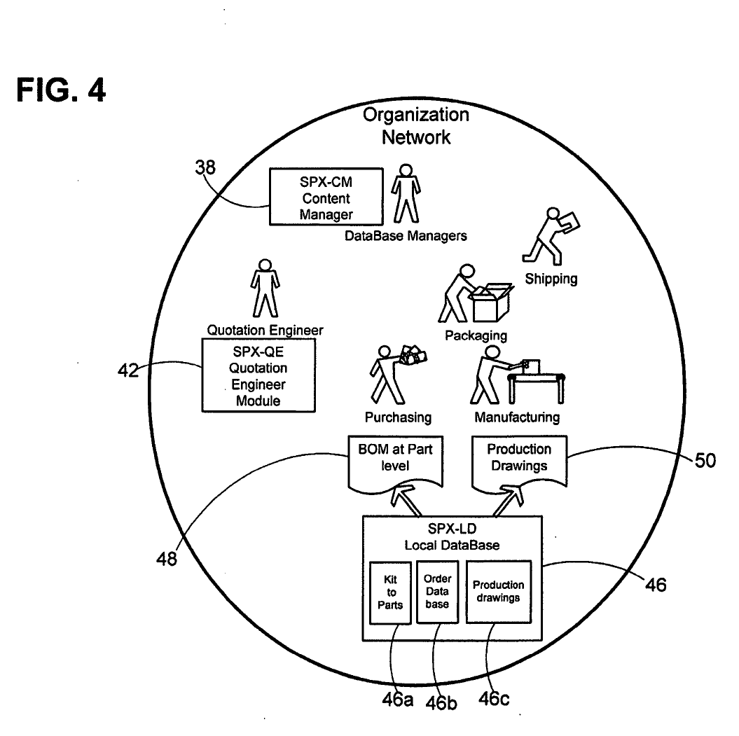

The organization network may also include a local database 46 that is accessible by manufacturing and purchasing departments of the organization. Upon receipt of a purchase order 22, the Local Database 46 provides access to various pieces for creating further documents to fulfill the received Order. Specifically, the Local Database 46 includes a Kit-to-parts database 46a for converting preexisting kit designs called out in the received Order into a Parts List 48 (FIG. 4). The Local Database 46 also provides access to an Order database 46b for storing the received Order in a repository with other orders. In the illustrated embodiment, the Local Database 46 also provides access to a Production drawings database 46c, in order to generate appropriate Production Drawings 50 (see FIG. 4) as part of the requisite documents for order fulfillment, when such are required.

As shown in FIG. 1, by way of a network connection 52, information concerning a Quote, such as a Bill of Materials (BOM) at kit level may be passed via the Web Server component 26 located at the back-end computing system 14 to the Local Database 46 so that it a BOM at part level may be created for the system.

In this way, certain output documents may be advantageously be provided to other facets of the organization for fulfillment of an Order. That is, the Local Database 46, via access to a BOM at kit level located at the back-end server system 14, may be configured to create a BOM document 48 that provides a BOM at a part level granularity. Such BOM 48 may be passed to a Purchasing Department of the organization for appropriate processing. In addition, the Local Database 46 may be configured to create a set of Production Drawing documents 50 that are passed to a Manufacturing Department. Upon receipt of the latter documents, the various entities in an organization, such as the Purchasing Department and Manufacturing Department may undertake appropriate steps to fulfill the order, and send it to Packaging and Shipping.

While the invention may be employed to fully integrate the various groups in an organization, as shown in FIGS. 1 through 4, those skilled in the art should appreciate that the invention may alternatively be used to automate of one or more of the functions of one or more of these entities. Also, one or more of the various entities, while shown in FIG. 1 as part of a single organization, may be loosely coupled with each other such as through partnership or vendor-vendee relationships and the like.

FIG. 1 also shows a Quotation Browser component 52 as one of the application programs executing on the sales office computer 16. By way of a network connection 54, the Browser component 52 enables the sales personnel to access, via the Web Server 26, other quotations that have been stored at the back-end server 14.

As discussed below, other materials, such as documentation relating to the proposed solution are similarly generated and transmitted to the computer 12. Similarly, a Purchase Order 22 may be uploaded from the first computer 12 by a salesperson by way of a network to the local database 46 as well as the back-end 14. As shown in FIG. 1, the server 14 may be connected via an intranet or other suitable network to other computing systems disposed proximate the server 14. Information relating to the order is then transmitted to appropriate persons or divisions of a firm for manufacture of the ordered product, such as purchasing, manufacturing and testing, and shipping departments.

In accordance with one aspect of the present invention, a computerized expert system enables a user, such as a salesperson, to easily specify a complex customized project for manufacture, making the sales process easier while achieving substantial savings in engineering time. A computer operated by the user is configured to run a graphical application program that interactively guides the user in the preparation of a P&ID that meets the requirements of a customer. The program may be based in part on existing diagramming tools, such as Visio. The guiding takes the form of questions and selectable options that are presented to the user by way of an intuitive graphical user interface that is easy for sales personnel to use without interrupting their discussions of the project with customers. In particular, by clicking on appropriate parts of the page with a mouse or other pointing device, the user causes the system to display corresponding popup windows or popup menus in which the user can supply input. Based on answers supplied by the user to particular questions, additional questions may be presented by the system, as the project is specified. Algorithms and logic associated with the interactive specification process permit proper values and components to be selected for the project.

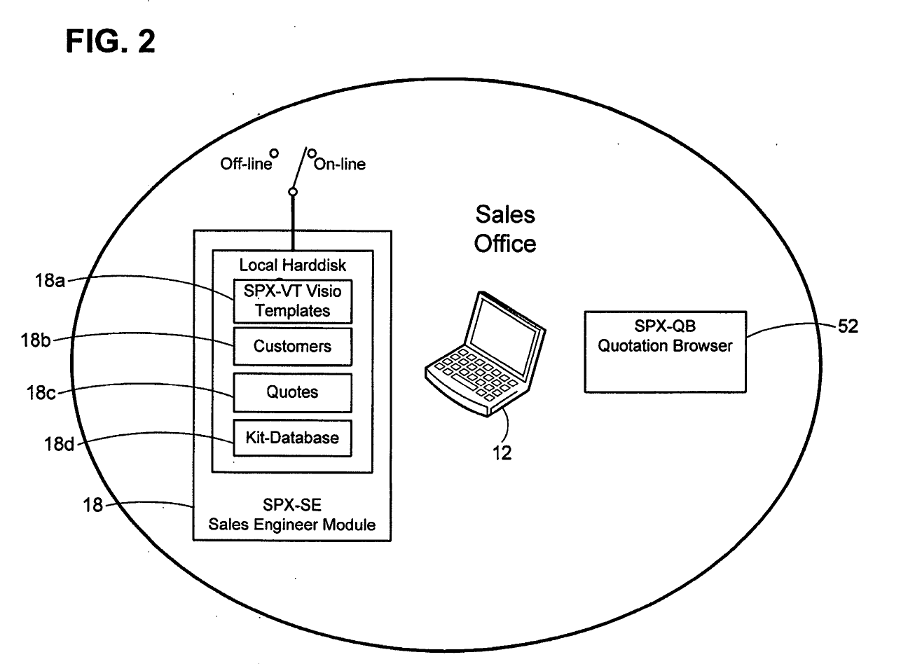

FIG. 2 illustrates various application programs and tools, running on the first computer 12, that are used to implement one embodiment of the invention. As explained above, this computer 12 is typically configured for operation by sales personnel at a remote location. The first computer 12 includes a Sales Engineer software module 18 which contains functionality, through access to other application programs, for creating pricing quotations. Among other things, this program preferably includes pricing information concerning standard spray solutions. In addition, the software module 18 includes (or accesses) a Graphics program 18a that contains predetermined Graphics Design Templates. Through interaction with the Sales Engineer software module 18, the Graphics program provides functionality for presenting a user interface to lead the user through a series of questions to the user and logic for designing a standard spray solution. In a preferred embodiment, this program may be implemented in Visio to include various preset design templates corresponding to design a standardized system design solution. Thus, when used for designing standardized spray system solutions, the Graphics program 18a may include a Flomax™ gas cooling system template including standard components for such a system.

In addition, the Sales Engineer software module 18 includes (or may access) a customer list 18b that contains information concerning current customers. The Sales Engineer software module 18 further may access a file 18c that contains a collection of prior quotes, i.e., a collection of objects that are represented by a XML file and a Visio file, that are resident on the remote system. For preparing proposal and quotation documents, the Sales Engineer module 18 further includes a Kit database 18d containing preexisting kits and components that is accessed by the software module 18.

For preparing a proposal document, the Sales Engineer software module 18 accesses, by way of a network connection 24, the Proposal Generation component 32 (see FIG. 3) maintained at the back-end 14. As described above, this component, in conjunction with the Database Webservice and FileServer Webservice components, access various templates located at the back-end system 14. Such templates are used for generating proposal documents and quotation documents in a desired format, such as Word or .pdf format. The templates preferably include information related to the customer, design parameters, spray solution details, a list of deliverables, pricing and optionally other information that is automatically inserted into the proposal document.

Preferably, the various components that are accessible locally by the Sales Engineer software module 18 enable sales personnel to create proposal documents, such as a price estimate, without accessing the global data back-end 14. Because the Sales Engineer module 18 preferably retains records of preexisting kits, components and prices based on prior information downloaded from the back-end system 14, the Sales Engineer module 18 may be used to generate proposal documents based on such data without establishing a connection to the back-end 14.

While the invention may be implemented with the application programs shown in FIG. 2, the functionality may alternatively be employed in many other variations.

In accordance with one aspect of the invention, the system performs various steps to automatically complete a design quotation and solution. Because it preferably utilizes known components, the system creates a design solution that meets the customer needs, while at the same time, reduces engineering and design costs. The method steps according to the invention may be performed through processing the responses to a series of preselected queries provided by the system to a user.

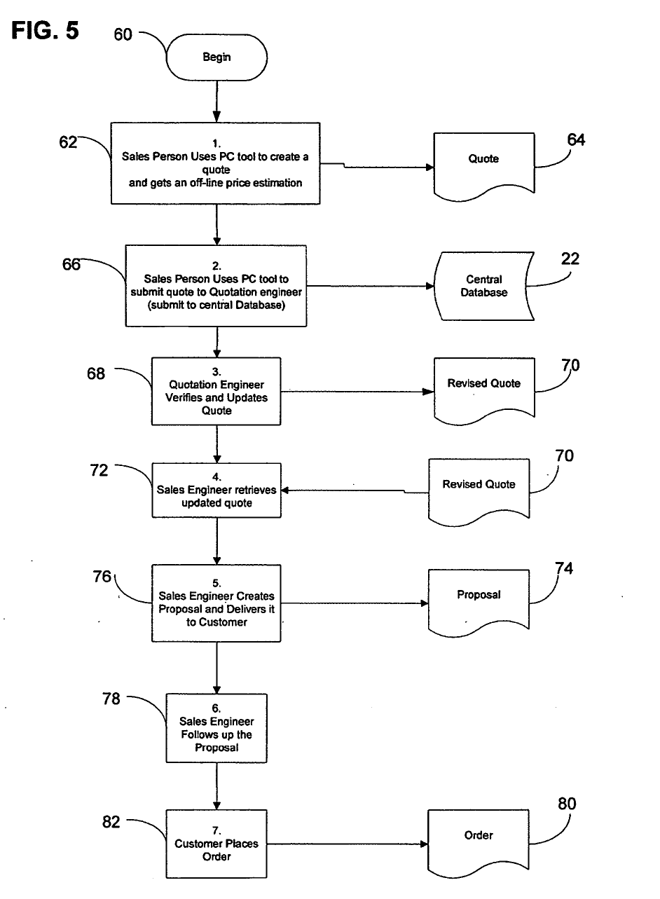

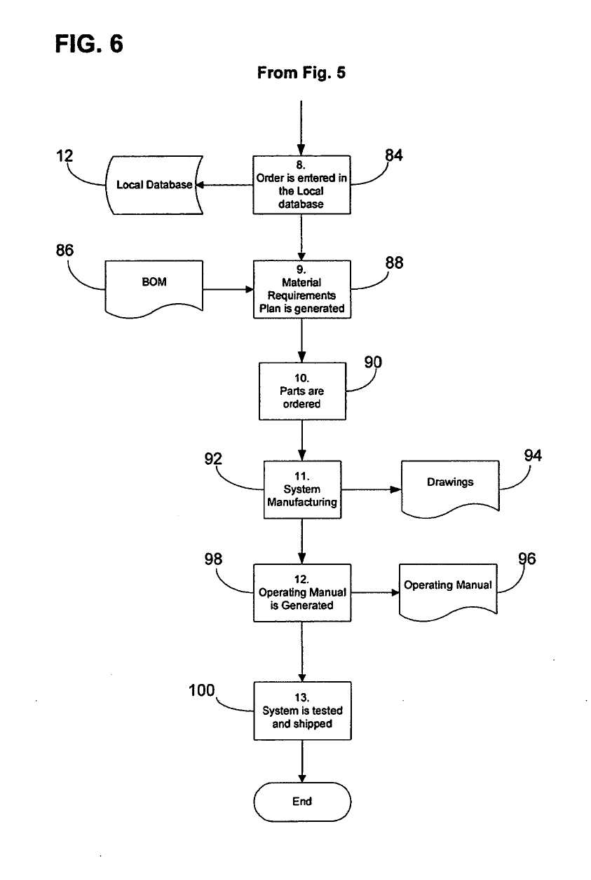

FIGS. 5 and 6 illustrate a preferred implementation of the invention for automatically generating a quotation and supporting documentation for a project. This embodiment operates to generate a price quotation and manufacturing plan for a project configured by way of the expert system or intelligent drawing tool. In the illustrated embodiment, the process begins at a block 60, as shown in FIG. 5. The method proceeds to a next step 62 in which a user, such as sales personnel, creates a preliminary price estimate for the project. As explained above, the user operates a local computer (such as the computer 12 shown in FIG. 1) in accordance with application programs running thereon. These application programs include a Sales Engineer module 18 that enables the user to create a preliminary quote. This preliminary quote is generated in response to a series of queries that are provided to the user.

Based on the responses, the Sales Engineer module 18 creates the XML files and Visio files necessary to describe the project. In this way, the Sales Engineer module generates an off-line preliminary Quote 64.

At a next step 66, the user initiates a transfer of the preliminary Quote through the Sales Engineer module. At this step, files associated with the preliminary quotation are uploaded to the remote server 14 linked to Database 28 and File Server 30. The files are in a suitable format, such as XML files containing data extracted from Visio files. The salesperson or other user may be guided by an interactive wizard application in entering the information to be uploaded to the server.

Once the relevant files containing the preliminary quotation data are transferred to the central database 28 and File Server 30, a quotation engineer accesses the data via interaction with the Quotation Engineering module 42 as shown in a next step 68. In this step, the quotation engineer verifies the proposed quotation and provides any updates as necessary. As shown in FIG. 1, the quotation engineer typically accesses the preliminary quotation data via network access to the back-end system 14. Once the quotation is updated, the quotation engineer saves the updated quotation in the central database 28 as an updated or Revised Quotation 70.

At a next step 72, the sales engineer obtains the Revised Quotation 70 via transmission over the network link 24 as shown in FIG. 1. Based on the documents contained in the Revised Quotation, the sales engineer creates a formal Proposal 74 at a next step 76. The Proposal includes necessary document files that describe the system or project that will be implemented. These document files are delivered to the customer.

The sales engineer thereafter follows up with the customer to verify that the Proposal meets the requirements for the project, as shown at a next step 78. At this step, any changes are made to the Proposal as desired by the customer. These changes may be transmitted to the back-end server 14 and reviewed by the quotation engineer if desired.

When the Proposal is acceptable, the customer places an Order (denoted in FIG. 5 as numeral 80) as shown at a next step 82. According to an illustrated embodiment, the document files in the Order 80 are preferably entered in the local database at the sales engineer's computer 12, as shown by a next step 84 in FIG. 6. Such files may also be transmitted to the central server 14 for storage on the central database 28.

In response to the generation of the Order, the Sales Engineer module 18 generates a Bill of Materials (BOM) 86 at a next step 88. Based on the BOM, the Sales Engineer module further generates a Materials Requirements Plan. The requirements plan is transmitted to the Local Database 46 and the Database 28 located at the back-end 14. Upon receipt of the requirements plan, the parts required for the project build are automatically ordered, as shown at a step 90. In addition, at a step 92, the Manufacturing Facilities for the organization accesses the transmitted data and prepares a complete set of engineering drawings 94 for the project build.

Optionally, the system also automatically generates an operating manual 96, as shown at a next step 98. These documents may be transmitted to the local computer 12 or transmitted to the customer by any conventional means.

Finally, at a next step 100, the created system is tested and shipped to the customer.

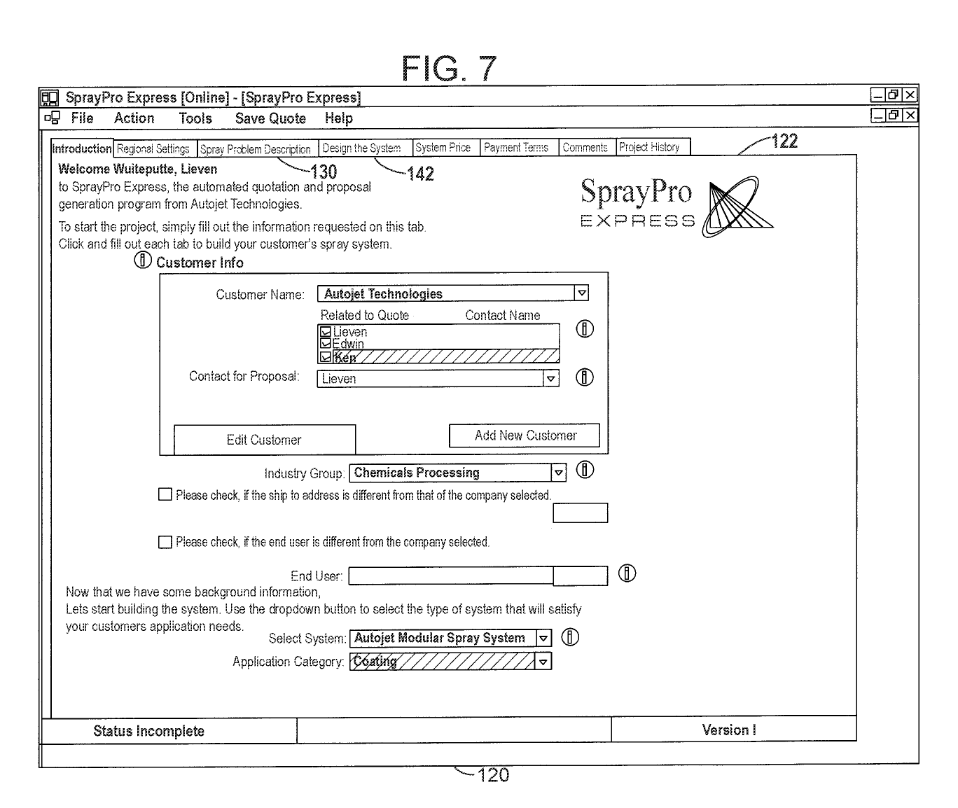

For simplifying and automating the design and build process, the Sales Engineer software module includes a user interface 120 that presents various selectable screen displays to the sales engineer. In an illustrated embodiment, the screen displays present a Windows based interface for logically directing the sales engineer through the design process for a spray system. As shown in FIG. 7, a preferred user interface 120 has a layout that includes various icons, buttons, tabs, drop-down menus and other user-selectable fields adapted to receive input information relevant to the design of the proposed system. For example, the user interface 120 may include a user selectable Introduction tab 122 that presents an initial screen for the automated quotation and proposal generation program. This screen display includes fields for entering customer information. For example, in the illustrated embodiment, a customer name field may be presented in the form of a drop-down menu to permit selection by the sales engineer. As shown, the customer name is associated with contact information for the principal customer contacts. In addition, the screen display includes fields for entering an industry group, type of system, and application category for the spray system to be designed by the expert system.

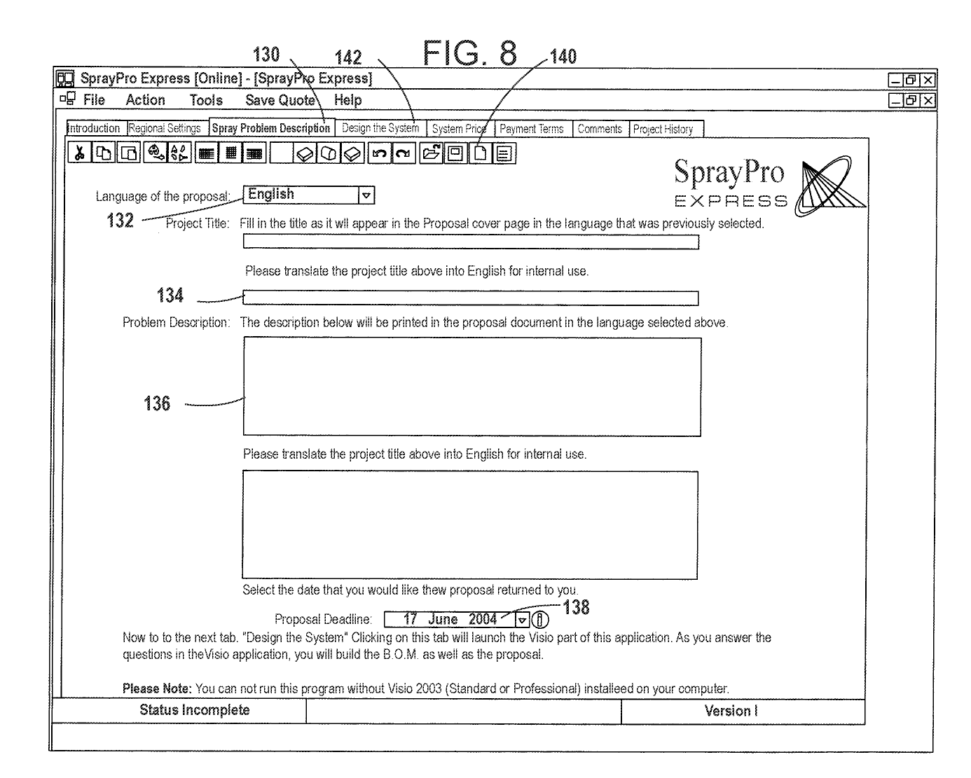

FIG. 8 illustrates a screen display that is presented upon selection of a Spray Problem Description tab 130. For providing the information in various languages, the screen presents a drop-down menu 132 for selecting the language of choice for the proposal. This screen display also presents an input text box 134 for the project title for the proposal. In addition, a Problem Description input text box 136 permits the sales engineer to enter information concerning the type of design problem to be solved and other pertinent information that may be later used by the expert system either to provide a solution for the current problem or for other solutions in other contexts, such as for presenting solutions for later implementations. Finally, the screen display shown in FIG. 8 includes a Proposal Deadline field 138, which may be implemented as a drop-down text box as shown. Optionally, the screen display may include buttons 140 for assisting the sales engineer in editing and otherwise processing the text, such as those typically encountered in a Microsoft Office environment.

In accordance with the invention, an expert system presents standardized design kits and templates as the building blocks for creating a system or design solution that is specific to customer needs. In addition to usage of preselected kits that are built from verified components, the system preferably employs known operating parameters for interconnecting such kits and components into the designed solution.

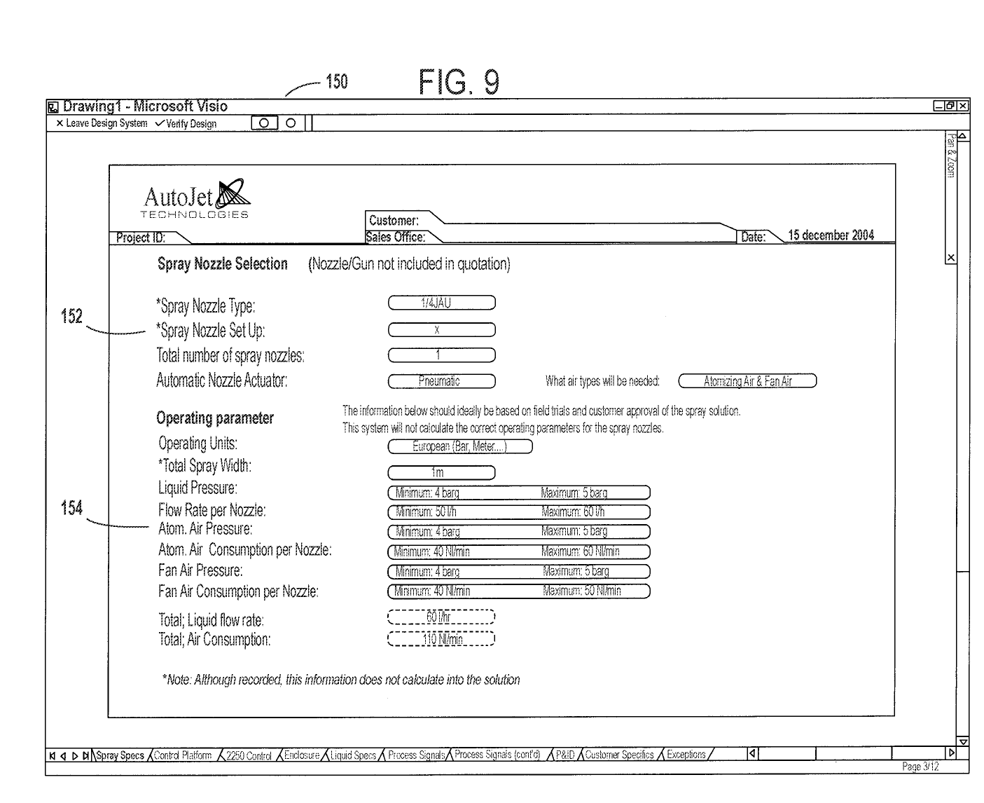

In the illustrated embodiment, the Sales Engineer module 18 instantiates a drawing application, such as Microsoft Visio, when the sales engineer selects a Design The System tab 142 shown in the screen displays of FIGS. 7 and 8. The user is then guided through various screen displays to aid in the description of the proposed and creation of the system design proposal documents. For example, the expert system may present the sales engineer with a logical series of interactive queries, such as shown in the screen displays of FIGS. 9 through 18. In this embodiment, the various displays are selectable by the sales engineer through selection of tabbed pages.

FIG. 9 illustrates a screen display 150 for providing the sales engineer with a user interface for entering spray specifications for designing the system. As noted above, this display may be provided through a drawing application such as Microsoft Visio. The screen display 150 includes various input text boxes 152 for spray nozzle selection. In the illustrated embodiment, the text boxes include fields for designating the spray nozzle type, spray nozzle set up, total number of spray nozzles for the proposed system, nozzle actuator and air types that are necessary. In addition, the Spray Specification screen display includes text boxes for entering operating parameters for the system. These include operating units, as well as spray characteristics for the system such as total spray width, liquid pressure minimum and maximum values, and flow rate per nozzle minimum and maximum values. In addition, the screen display 150 provides text boxes for entering air characteristics for the proposed system, such as atomized air pressure minimum and maximum values, atomized air pressure consumption per nozzle minimum and maximum values, fan air pressure minimum and maximum values and fan air consumption per nozzle minimum and maximum values. Finally, the spray specification screen display includes text boxes for total liquid flow rate and total air consumption.

In the illustrated embodiment, the information provided into the specification for the system is determined by the sales engineer based on field trials and customer approval of the proposed solution. However, in accordance with another embodiment of the invention, the input boxes are presented with default values intelligently calculated based on known characteristics for the type of system being designed.

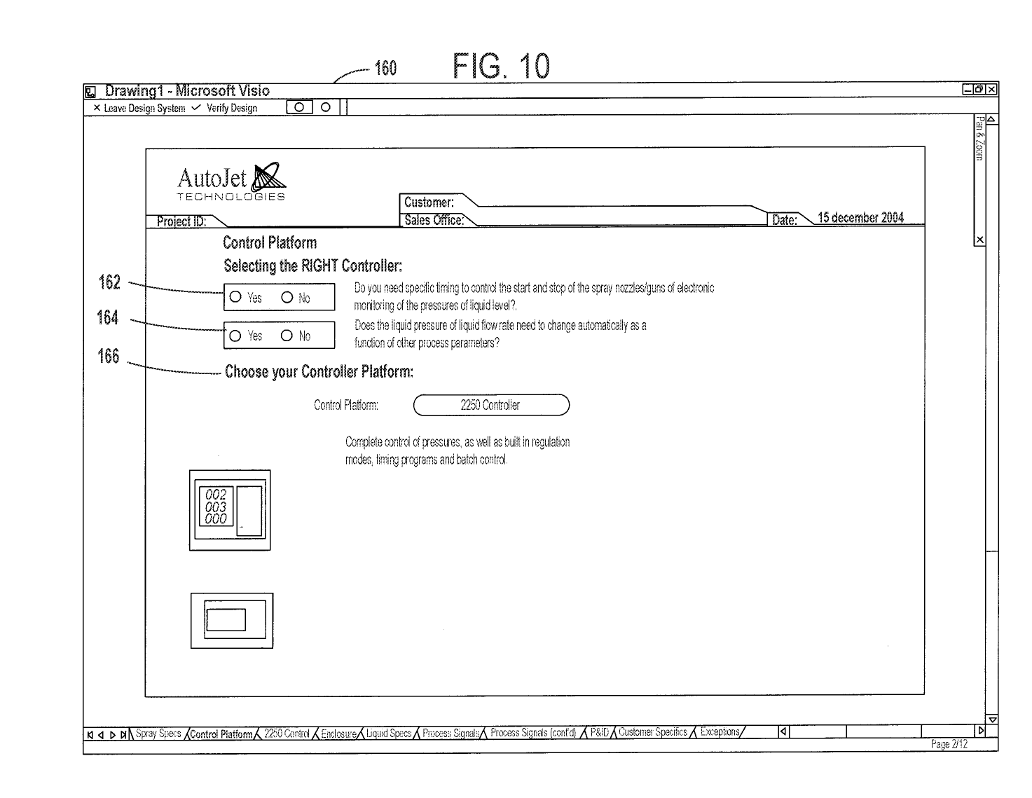

FIG. 10 illustrates a further screen display 160 for providing user selectable information concerning the control platform for the proposed design. As shown, the screen display intelligently queries the sales engineer to input the requirements for the desired controller solution with use of dialog boxes 162, 164. Of course, such information may be requested in any number of dialog box implementations or interactive methodologies. In addition, the screen display 160 presents the user with a text box 166 for entering the desired control platform.

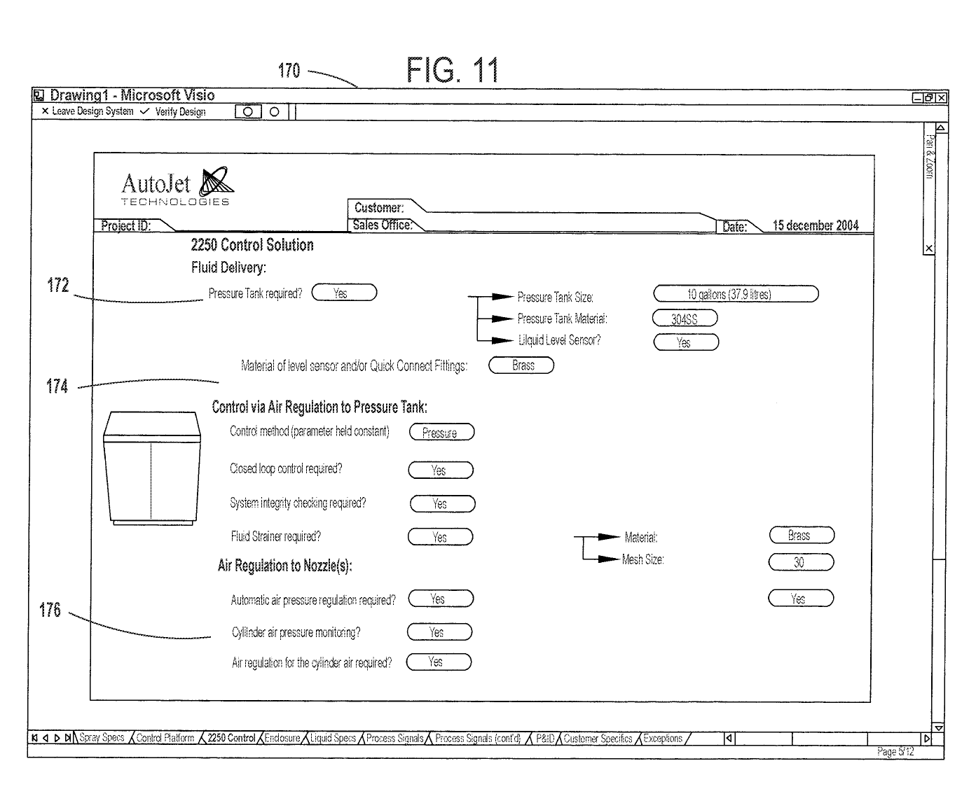

The expert system may include further screen displays for selection of a solution relating to the control platform specification. In the illustrated embodiment, upon selection by the sales engineer of a specific control platform, the system may present a further screen display for control parameters relating thereto. FIG. 11 shows one such screen display 170. This control platform-specific screen display presents the user with dialog boxes and text boxes for selecting desired control solution characteristics. For example, the screen display 170 includes a fluid delivery section 172 including dialog boxes relating to pressure tank requirements. In addition, the screen display 170 provides a Control via Air Regulation to Pressure Tank section 174 including dialog boxes relating to air pressure regulation for the system. Finally, the screen display 170 includes an Air Regulation to Nozzle(s) section 176 that includes dialog boxes relating to air regulation as it is output to the nozzles in the designed system.

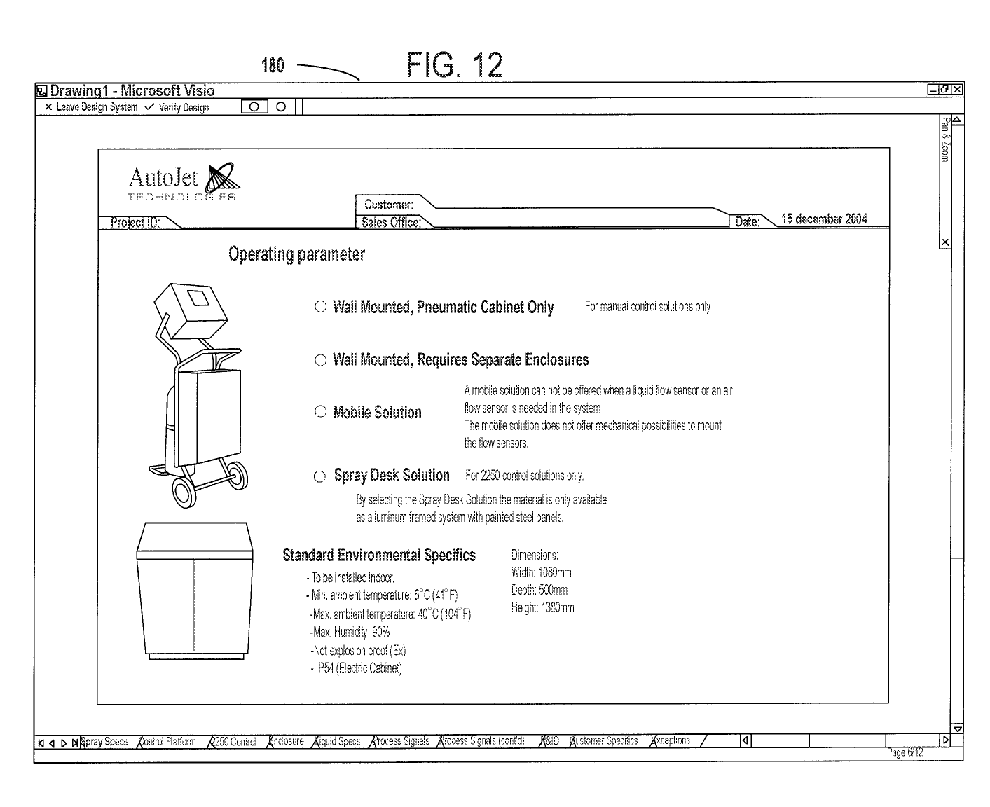

FIG. 12 illustrates a screen display 180 for providing user selection of an appropriate enclosure configuration for the spray solution. As shown, various dialog boxes aid the sales engineer in selecting an appropriate enclosure to house the control electronics of the designed system.

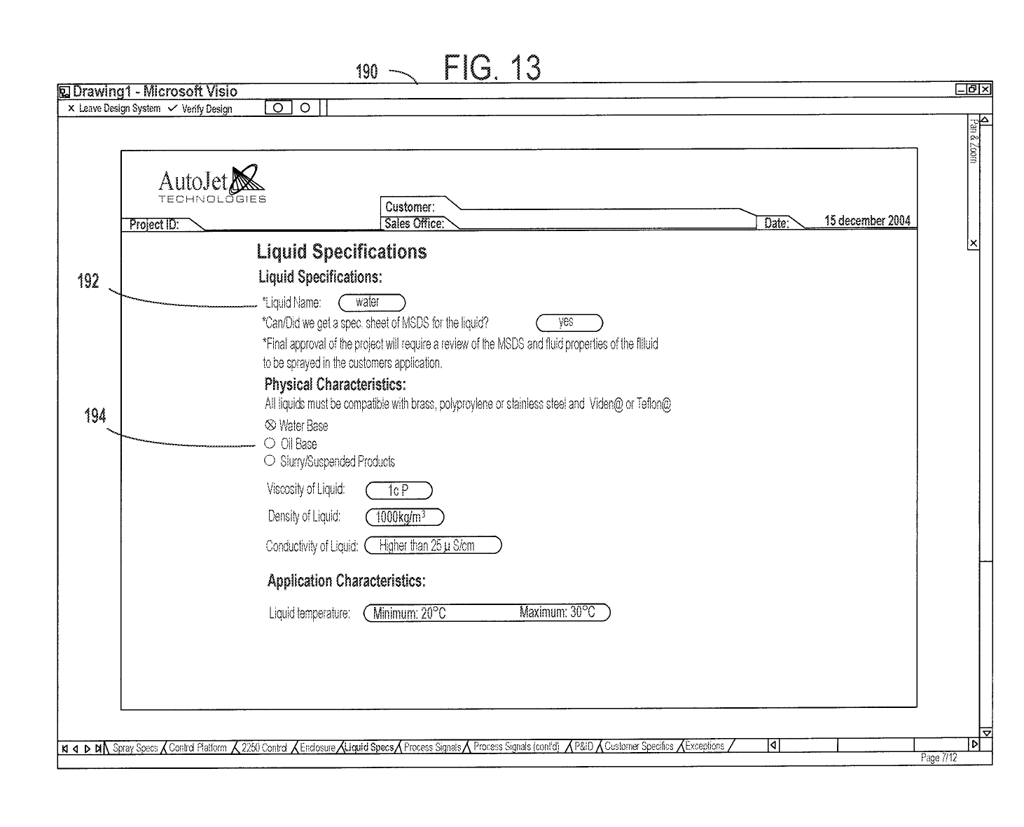

As part of the design of the proposed solution, the system presents a screen display for requesting input information concerning liquid specifications. As shown in FIG. 13, a screen display 190 includes a series of dialog boxes 192 for entering information concerning the liquid to be used in the design application. In addition, the screen display 192 provides various dialog boxes 194 for providing information concerning the physical characteristics for the specified liquid as well as application characteristics for the liquid.

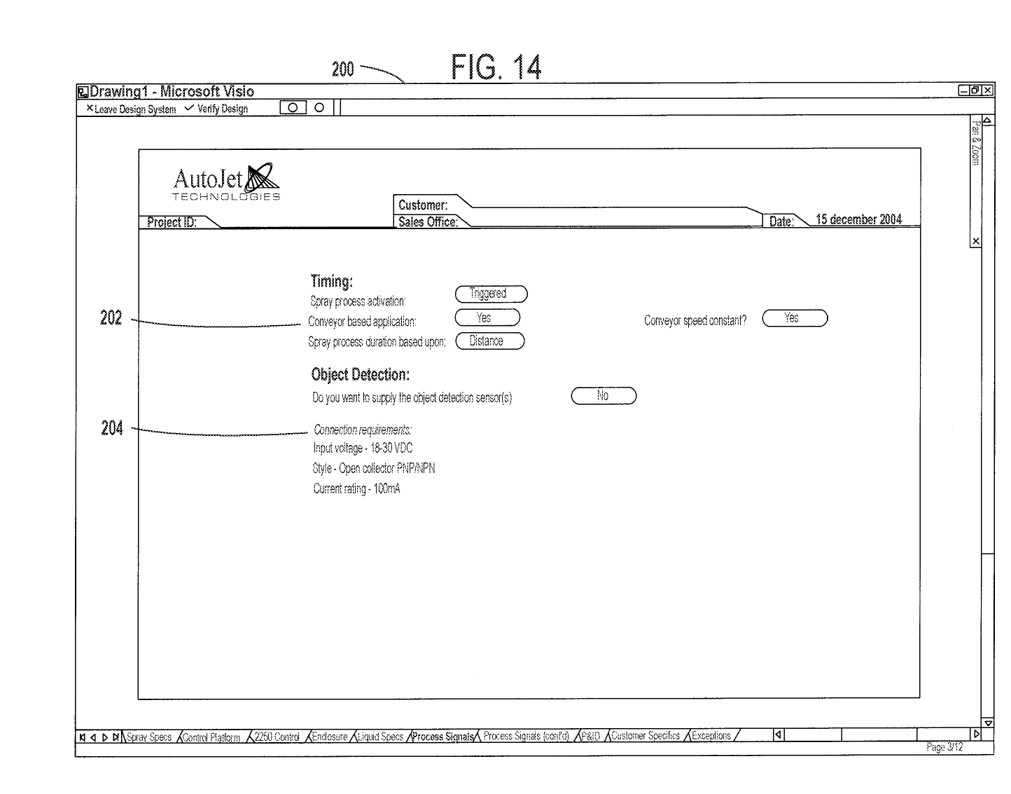

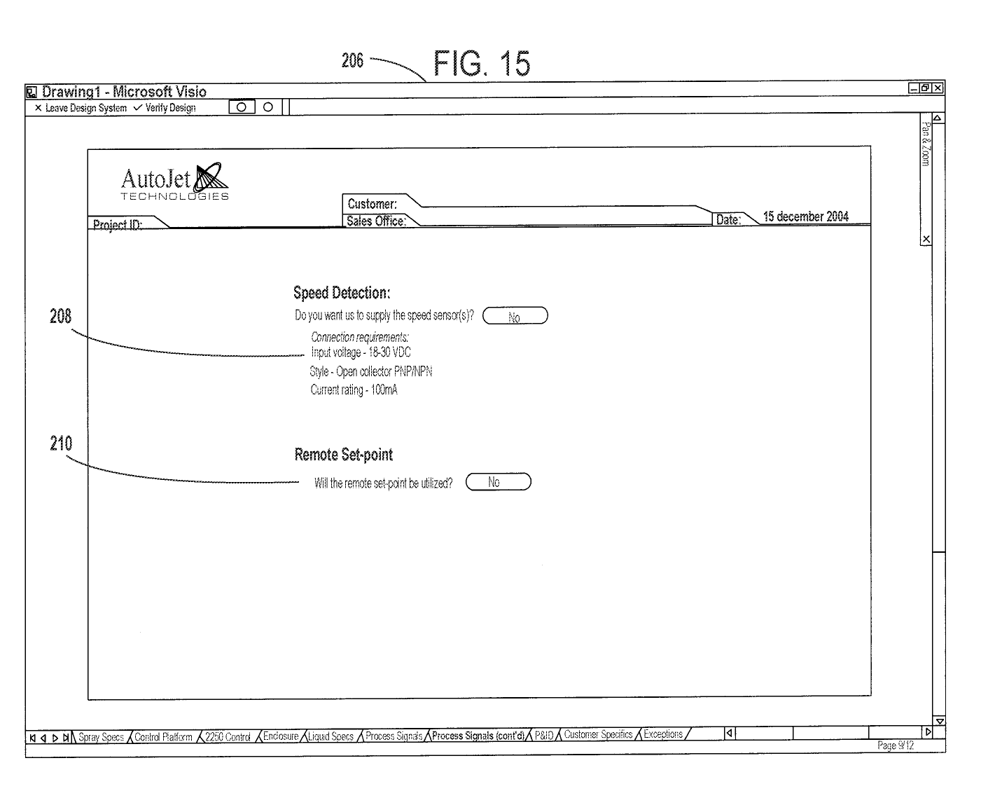

The invention next provides one or more screen displays for entering information concerning process signals for the designed system, as shown in FIGS. 14 and 15. Such information may be obtained by presenting one or more dialog boxes 202 and 204 relating to signal timing and whether object detection is desired, respectively, as shown in the screen display 200 of FIG. 14. A further screen display 206 (FIG. 15) presents the user with dialog boxes 208 and 210 concerning whether speed detection and whether a remote set-point capability are desired. Based on the data entered by the user, the expert system determines an appropriate process signals that are necessary for the design solution.

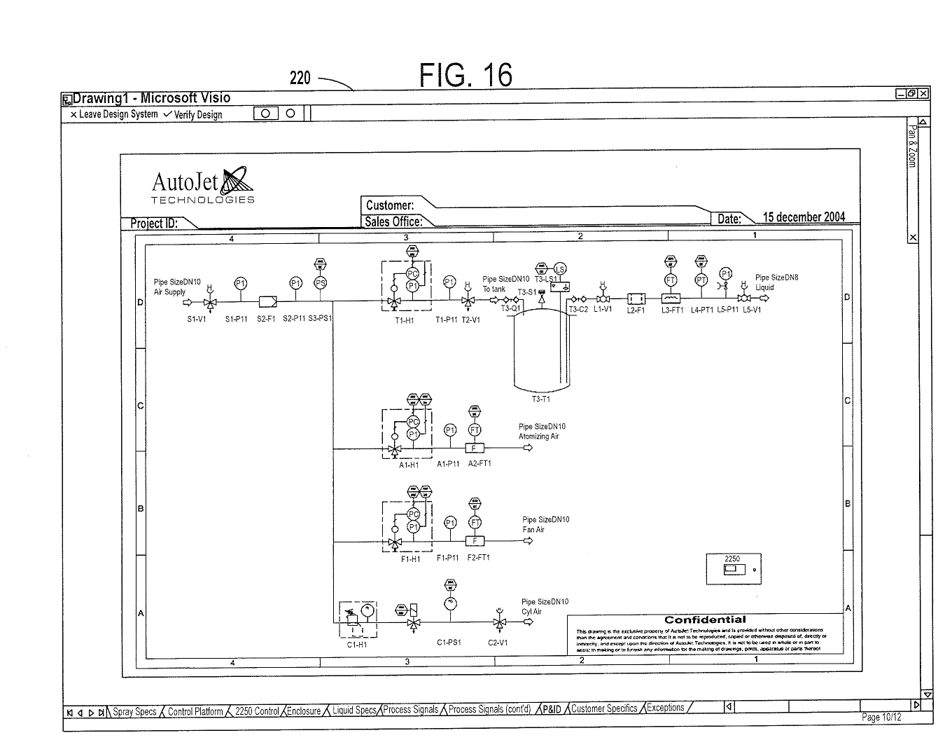

In accordance with one feature of the invention, the system automatically generates a design solution based upon the input information entered by the user. FIG. 16 illustrates a screen display 220 in which a P&ID diagram is automatically generated in response to the input information entered by the user. In the illustrated embodiment, the P&ID diagram shown in FIG. 16 is a preliminary diagram that is generated by the computer 12 operated by the sales engineer.

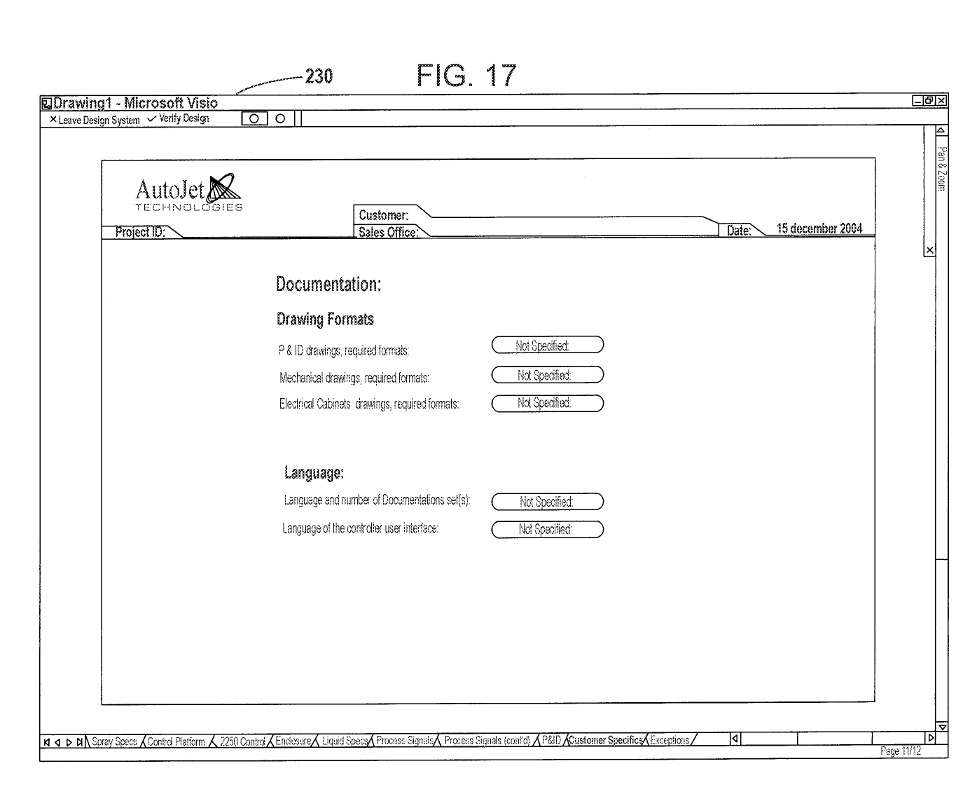

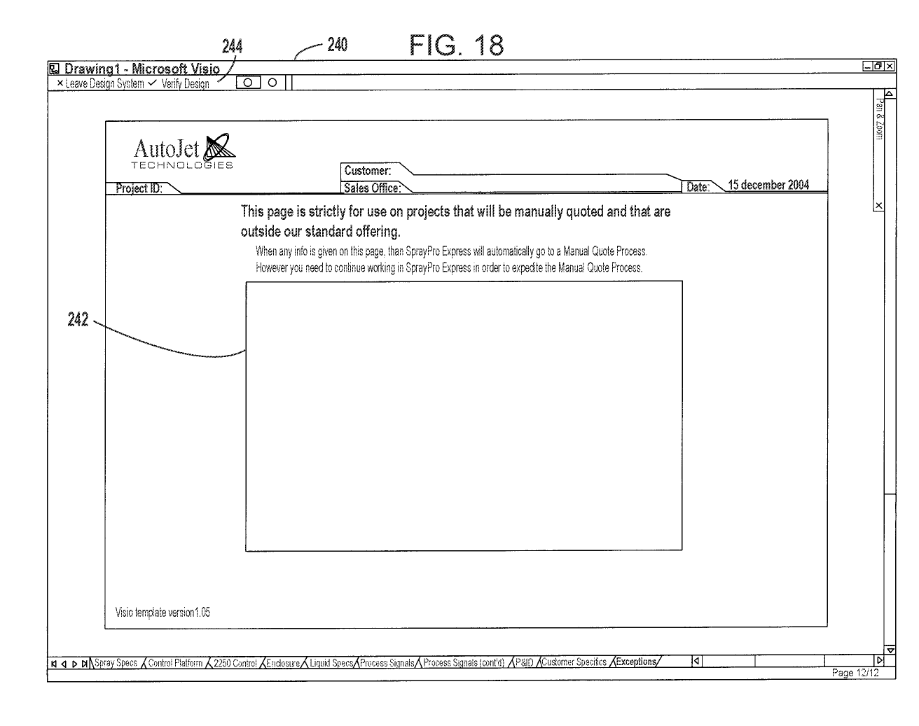

FIGS. 17 and 18 illustrate screen displays for entering additional information concerning the proposed design solution. The screen display 230 shown in FIG. 17 provides dialog boxes for selecting the appropriate documentation requirements, such as the type of drawings and format that the customer requires. FIG. 18 illustrates a screen display 240 which provides a text box 242 for entering information to describe a unique design problem. When the sales engineer enters information into this field, the system provides a more customer-specific quotation.

When the information has been input to the system, the sales engineer then may ascertain whether certain design criteria are met in the proposed solution via selection of a Verify Design button 244, which button is provided as part of the user interface in the displays shown in FIGS. 9 through 18. Specifically, the Design Templates component 48a includes code that is used to determine whether the design proposed by the sales personnel meets certain criteria. When an error is returned, the sales personnel is required to enter design changes that can be verified before a proposed solution and corresponding price estimate may be provided to the customer. Of course, upon completion of and submission of a Quote, as described above, a Quotation Engineer verifies that the Quote includes the necessary items.

That is, because, the design proposal comprises predefined component blocks, the system matches the required component blocks to corresponding entries in the database (either locally or remotely), each of which is associated with a Bill of Materials. Based on these matched components and other data a price quotation for the composite system is generated and transmitted to the salesperson. Thus, assuming all the component blocks are predefined blocks that are successfully matched in the database, the salesperson receives pricing information for the customer immediately. If the price is too low or high the salesperson and customer can then make changes to the project configuration. If a component kit or block is “special” (not predefined), a bill of materials for the component is developed manually.

Accordingly, a complete composite Bill of Materials for the design project is generated immediately, instead of taking days or weeks to prepare manually. Then, a report for the proposed order, including pricing information, is generated. As explained above, depending on the customer requirements, a customized operating manual for the system to be manufactured may optionally be generated. In this example, the component function blocks in the P&ID are associated with a functional text description, contained, for example, in a Microsoft Word document file associated with the Visio files for the project. The generation of the proposal includes the meaningful concatenation of these component text descriptions. Similarly, the text descriptions are used in automatically preparing the manual for operating the customized manufactured system, so that the lengthy process of having an engineer write a customized manual is avoided. If the customer places a purchase order based on the price quotation, subsequent steps relating to the fabrication of the system are taken, including the generation of a material requirements plan and the actual manufacturing and shipping of the system.

In this way, the system automatically generates a P&ID based on answers and other input supplied by the user in previous pages. The user thus does not engage in the difficult task of building a P&ID manually, by dragging and dropping components. The constituent elements of the diagram are preferably kits or blocks. As such, these blocks in general are predefined, encapsulated components having their own configurable options. The generating of a system based on these constituent blocks permits the standardization of solutions for customers, which in turn allows pricing to be standardized and predictable. The kits or blocks are designed to be associated with standard quantities or multiples of standard quantities, to the extent possible. This facilitates the determination of the size of an order before it is actually designed.

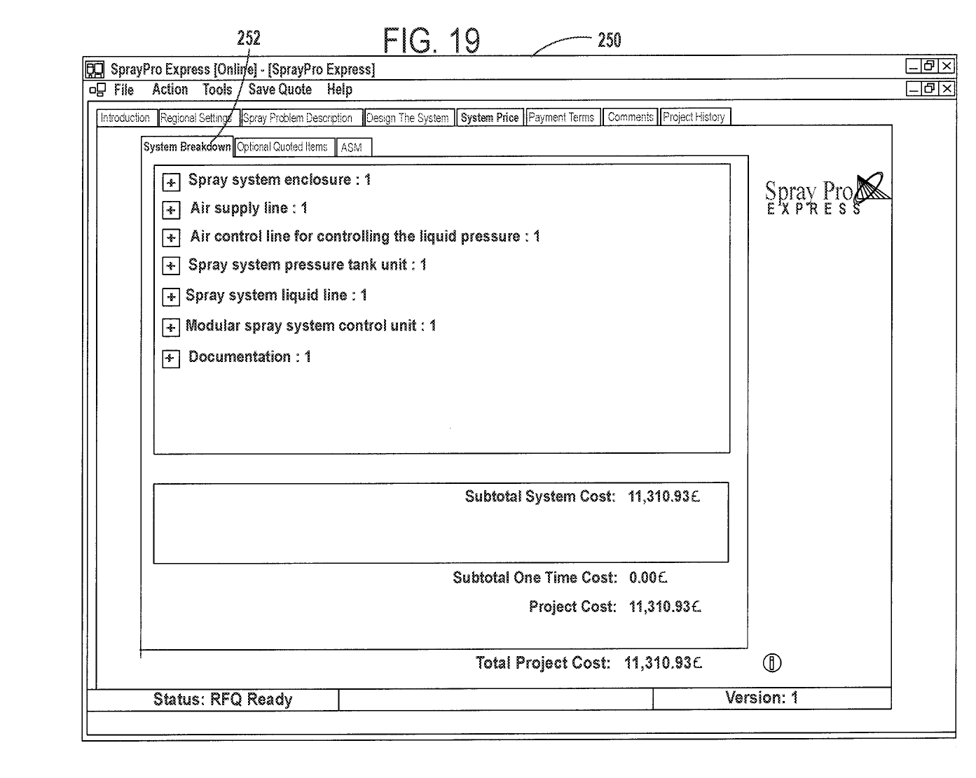

In its main page interface, the Sales Engineer software module presents tabs for selecting other screen displays or pages as well. FIG. 19 illustrates a System Price screen display 250 that is selectable after the system is designed according to the invention. As shown, the expert system automatically generates a preliminary project cost based on the component items selected by the sales engineer. In addition, the expert system presents an itemization of components for the system in a page 252 that is accessible through selection of a System Breakdown tab.

Other selectable tabs may be included in the main screen display, as shown in FIG. 7. For example, the system may include a Regional Settings tab that permits the sales engineer to enter information concerning the destination for the project design. Similarly, the screen display may include tabs for entering Payment Terms, additional Comments, and a Project History.

Accordingly, a system and method meeting the aforestated objectives has been described. The system may be integrated to provide a complete design solution for a customer, based on a series of preselected queries provided to sales personnel, such as a sales engineering staff that interacts with a customer. The system advantageously provides improved uniformity in design solutions, while substantially reducing design cost and the time period for providing the solution.

Those skilled in the art should appreciate that the invention is not intended to be limited to the above described currently preferred embodiments of the invention. Various modifications will be apparent, particularly upon consideration of the teachings provided herein. That is, certain functionality that has been described in conjunction with software components of the system may be combined with other components, or alternatively, be implemented in numerous other ways, whether by other software and/or hardware implementations. Also, although the invention has been described in the context of interactions of various computing systems in a network configuration, those skilled in the art will recognize that many other configurations may be employed. Thus, the invention should be understood to extend to that subject matter as defined in the following claims, and equivalents thereof.

1-17. (canceled)

18. A method for generating a sales document relating to a system design, the method comprising the steps of:
creating a plurality of design templates implementing a plurality of standardized system designs;
receiving information from a customer concerning a system desired by a customer;
correlating the information concerning the system desired by the customer with at least one of the plurality of design templates to obtain a proposed system design;
preparing a preliminary price estimation for the proposed system design based upon at least one of the plurality of design templates;
transmitting the preliminary price estimation for the proposed system design to a central location;
receiving a quotation from the central location, the quotation generated as a result of comparing the information concerning the at least one design template with standardized pricing information; and
creating a proposal from the quotation.

19. The invention of claim 65 further comprising the steps of:
submitting the quotation to the customer;
receiving an order for the product in acceptance of the quotation; and
automatically generating a bill of materials in fulfillment of the order.

20. The invention as in claim 66 wherein the bill of materials is generated at the central location.

21. The invention as in claim 67, wherein the bill of materials is a kit-level bill of materials, the method further including the steps of:
converting the kit-level bill of materials to a part-level bill of materials; and
generating a material requirements plan based on the generated part-level bill of materials.

22. The invention as in claim 68 further including the step of:
generating manufacturing drawings for the product based at least in part on the materials requirements plan.

23. The invention as in claim 69, wherein the product is a spray application.

24. The invention as in claim 65, wherein the plurality of design templates define a plurality of spray applications.

25. The invention as in claim 70, wherein the spray application is a spray system that includes a plurality of configurable spray nozzles.

26. The invention as in claim 72 wherein the generated manufacturing drawings include a piping and instrumentation diagram for the spray system.

27. The invention as in claim 73 further including the step of updating at least one design template to create a new design template defining a modified spray system.

28. A system for verifying a customized order for a system with a standardized system specification, the system comprising:
a first computing system configured to generate a proposed system specification based on a comparison of one or more system requirements with at least one standardized system template; and
a second computing system, linked to the first computing system, and configured to
(a) verify the proposed system specification by way of a database for correlating the components in the proposed system specification with a corresponding set of standardized prices for the components; and
(b) update the standardized system template by storing revised versions of the standardized system template in the database.

29. The system of claim 75 wherein the second computer is a server linked to the first computer by way of a network.

30. The system of claim 76 wherein the product is a spray application.

31. The system of claim 77 wherein the second computing system is further configured to generate a quote for the system.

32. A server for preparing and verifying a customized order for a spray system with the use of one or more standardized system specifications, the server comprising:
a communication module configured to receive a proposed system specification desired by a customer;
a quotation module, linked to the communication module, and disposed to
(a) correlate the proposed system specification with at least one standardized system template;
(b) generate a price quotation for the proposed system specification; and
(c) update the standardized system template by causing revised versions of the standardized system template to be stored in the database.
